(19) United States
(12) Patent Application Publication
(10) Pub. No.: US 2026/0277168 A1
(43) Pub. Date: Sep. 17, 2026

(54) SOLAR MOVEMENT AND TIMEPIECE

(71) Applicant: SEIKO WATCH KABUSHIKI KAISHA (trading as SEIKO WATCH CORPORATION), Tokyo (JP)

(72) Inventors: Masayuki KAWATA, Tokyo (JP); Ken SATO, Tokyo (JP); Katsuya MUGISHIMA, Tokyo (JP); Junya MASUDA, Tokyo (JP)

(21) Appl. No.: 19/542,069

(22) Filed: Feb. 17, 2026

(30) Foreign Application Priority Data
Mar. 13, 2025 (JP) 2025-039886

(51) Int. Cl. G04G 17/06; G04C 3/00; G04G 17/04; G04G 19/02; G04G 19/10

(52) U.S. Cl. CPC G04G 17/06; G04C 3/008; G04G 17/04; G04G 19/02; G04G 19/10

(57) ABSTRACT

There is provided a solar movement capable of improving productivity. The solar movement includes: a movement body including a battery housing portion configured to house a primary battery; a dial-side unit disposed on a dial side of the movement body and including at least a solar panel; a case-back-side unit disposed on a case back side of the movement body and having at least a part thereof housed in the battery housing portion; a secondary battery housed in the battery housing portion; and a motor driving unit driven by supply of power from the secondary battery. At least one of the dial-side unit and the case-back-side unit is provided with a printed wired board forming a circuit block including a charging circuit unit configured to control charging of the secondary battery with power supplied from the solar panel, and a driving circuit unit configured to control driving of the motor driving unit with power supplied from the secondary battery.

### RELATED APPLICATIONS

This application claims priority to Japanese Patent application No. JP2025-039886, filed on Mar. 13, 2025, the entire content of which is incorporated herein by reference.

### BACKGROUND OF THE INVENTION

### 1. Field of the Invention

The present invention relates to a solar movement and a timepiece.

### 2. Description of the Related Art

For example, there has been known a solar electronic timepiece that can be charged by light energy such as solar light. Such a timepiece includes a solar panel and a secondary battery. The secondary battery is charged with power from the solar panel and supplies power to a drive source of the timepiece.

Therefore, a solar movement compatible with the solar panel needs to include a connection unit that electrically connects the solar panel and the secondary battery, a charging circuit unit that controls charging of the secondary battery, and the like in addition to the secondary battery.

Incidentally, there has been proposed a timepiece including a solar panel and a secondary battery, in which when a primary battery is mounted instead of the secondary battery, the primary battery supplies power to a drive source (for example, see JP2013-68493A).

In general, a solar movement is designed and manufactured as a dedicated movement separately from a primary battery movement compatible with a primary battery. Therefore, even when similar designs are adopted in a plurality of models, it is necessary to prepare a plurality of types of movements depending on the presence or absence of the solar panel.

However, when the solar movement and the primary battery movement are designed and manufactured separately, the manufacturing process is diversified, and the number of components also increases. Therefore, there is room for improvement in terms of improving productivity of the movement and the timepiece.

### SUMMARY OF THE INVENTION

It is one aspect of the present application that has been made in consideration of the above circumstances, and an object of the invention is to provide a solar movement capable of improving productivity, and a timepiece including such a solar movement.

(1) A solar movement including: a movement body including a battery housing portion configured to house a primary battery; a dial-side unit disposed on a dial side of the movement body and including at least a solar panel; a case-back-side unit disposed on a case back side of the movement body and having at least a part thereof housed in the battery housing portion; a secondary battery housed in the battery housing portion; and a motor driving unit driven by supply of power from the secondary battery, in which at least one of the dial-side unit and the case-back-side unit is provided with a circuit block including a charging circuit unit configured to control charging of the secondary battery with power supplied from the solar panel, and a driving circuit unit configured to control driving of the motor driving unit with power supplied from the secondary battery.

According to this configuration, the solar movement can be easily implemented by incorporating the solar panel, the secondary battery, and the circuit block including the charging circuit unit and the driving circuit unit in the movement body compatible with a primary battery movement. As a result, it is not necessary to separately design and manufacture the primary battery movement and the solar movement, and an increase in the number of components can also be prevented, so that the productivity can be further improved.

(2) The solar movement according to the above (1), in which the circuit block is provided on the secondary battery with at least a part thereof housed in the battery housing portion.

According to this configuration, the configuration on a case-back-side unit side on which the circuit block is provided can be designed to be compact.

(3) The solar movement according to the above (2), further including: a first connection unit electrically connecting the secondary battery and the circuit block; a second connection unit electrically connecting the solar panel and the circuit block; and a third connection unit electrically connecting the motor driving unit and the circuit block.

According to this configuration, in the configuration in which the circuit block is provided on the case-back-side unit side, the secondary battery and the circuit block can be electrically connected to each other via the first connection unit, the solar panel and the circuit block can be electrically connected to each other via the second connection unit, and the motor driving unit and the circuit block can be electrically connected to each other via the third connection unit.

(4) The solar movement according to the above (3), in which the first connection unit includes a pressing member provided on the circuit block and including a terminal electrically connected to the circuit block, and a first coil spring electrically connecting the secondary battery and the pressing member.

According to this configuration, the secondary battery and the circuit block can be electrically connected to each other.

(5) The solar movement according to the above (3), in which the second connection unit includes a second coil spring electrically connecting the solar panel and the circuit block.

According to this configuration, the solar panel and the circuit block can be electrically connected to each other.

(6) The solar movement according to the above (3), in which the third connection unit includes a flexible wiring board electrically connecting the motor driving unit and the circuit block.

According to this configuration, the motor driving unit and the circuit block can be electrically connected to each other.

(7) The solar movement according to the above (1), in which the circuit block is provided in a region on the dial side of the movement body that does not overlap the solar panel.

According to this configuration, the configuration on a dial-side unit side on which the circuit block is provided can be designed to be compact.

(8) A timepiece including: the solar movement according to any one of the above (1) to (7).

According to this configuration, a timepiece having excellent productivity can be obtained.

As described above, according to an aspect of the application, a solar movement capable of improving productivity and a timepiece including such a solar movement are provided.

### BRIEF DESCRIPTION OF THE DRAWINGS

FIG. 1 is a perspective view of a solar movement according to a first embodiment of the invention as viewed from a case back side.

FIG. 2 is a perspective view illustrating a state of the solar movement illustrated in FIG. 1 with a case-back-side unit removed.

FIG. 3 is a cross-sectional view of the solar movement illustrated in FIG. 1.

FIG. 4 is a plan view of the solar movement illustrated in FIG. 1 as viewed from a dial side.

FIG. 5 is an exploded perspective view of the solar movement illustrated in FIG. 1.

FIG. 6 is a perspective view of a dial-side unit, the case-back-side unit, and a secondary battery that form the solar movement illustrated in FIG. 1.

FIG. 7 is an exploded perspective view of the dial-side unit, the case-back-side unit, and the secondary battery illustrated in FIG. 6.

FIG. 8 is an exploded plan view of a motor driving unit and a flexible wiring board that form the solar movement illustrated in FIG. 1.

FIG. 9 is a perspective view of the motor driving unit and the flexible wiring board illustrated in FIG. 8.

FIG. 10 is a block diagram of a circuit block of the solar movement illustrated in FIG. 1.

FIG. 11 is a cross-sectional view illustrating a state in which a primary battery is disposed in a battery housing portion of a movement body forming the solar movement illustrated in FIG. 1.

FIG. 12 is a perspective view of a solar movement according to a second embodiment of the invention as viewed from a dial side.

### DETAILED DESCRIPTION OF THE PREFERRED EMBODIMENTS

Hereinafter, embodiments of the invention will be described in detail with reference to drawings.

Note that the invention is not limited to the following embodiments, and can be appropriately modified and implemented without changing the gist thereof.

### First Embodiment

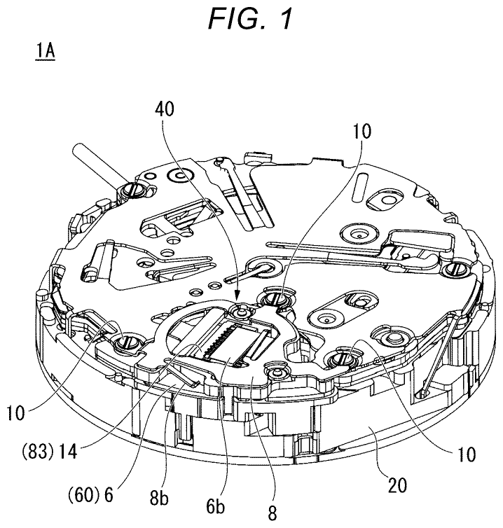

First, for example, a solar movement 1A illustrated in FIGS. 1 to 11 will be described as a first embodiment of the invention.

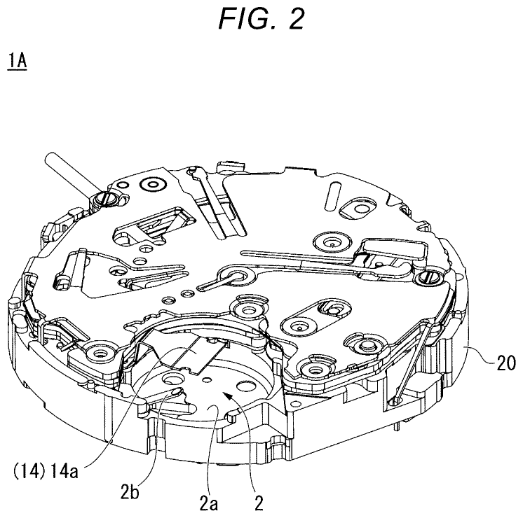

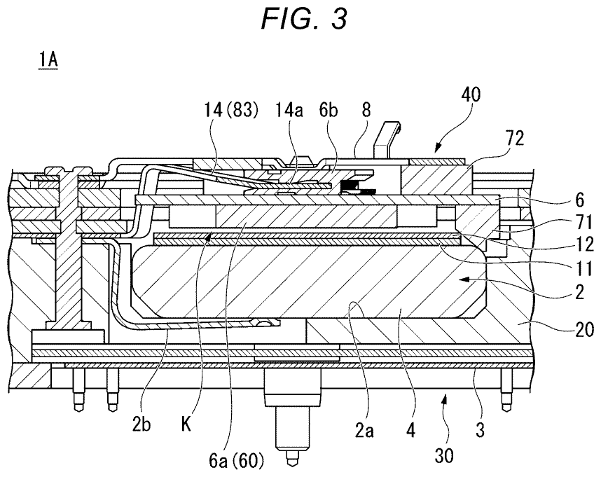

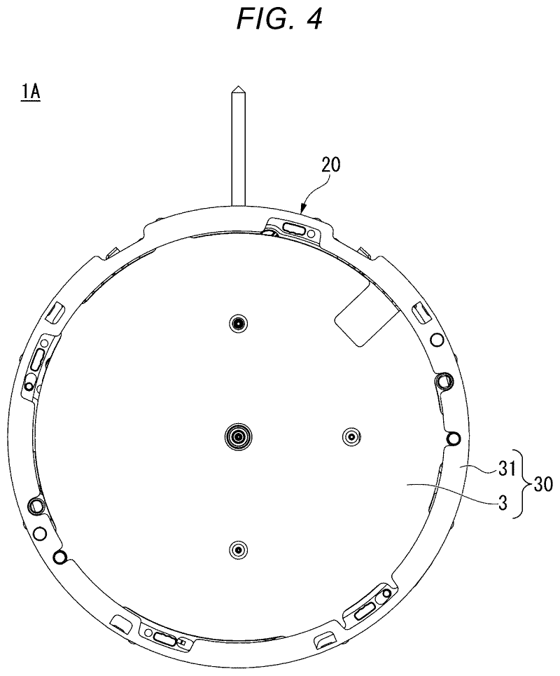

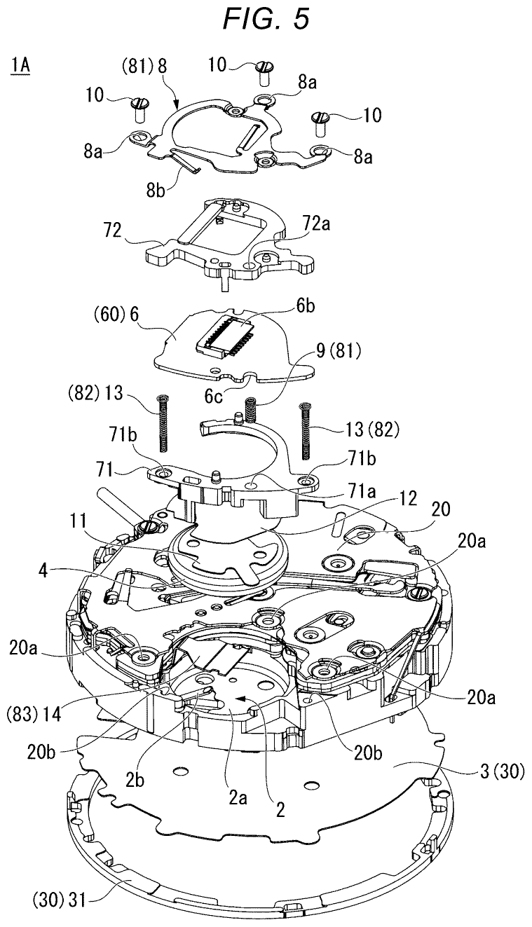

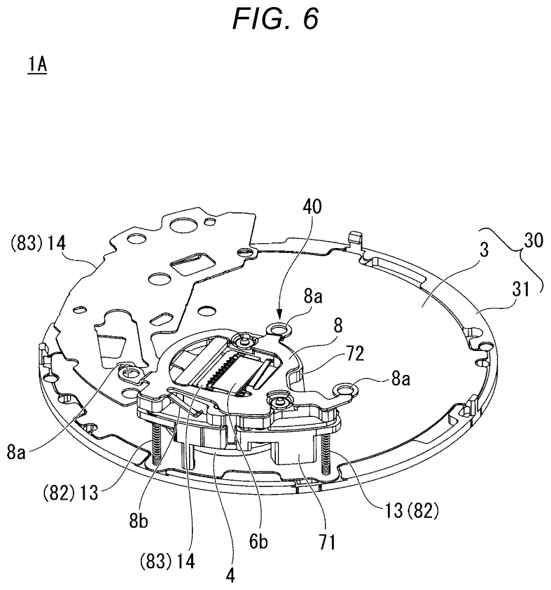

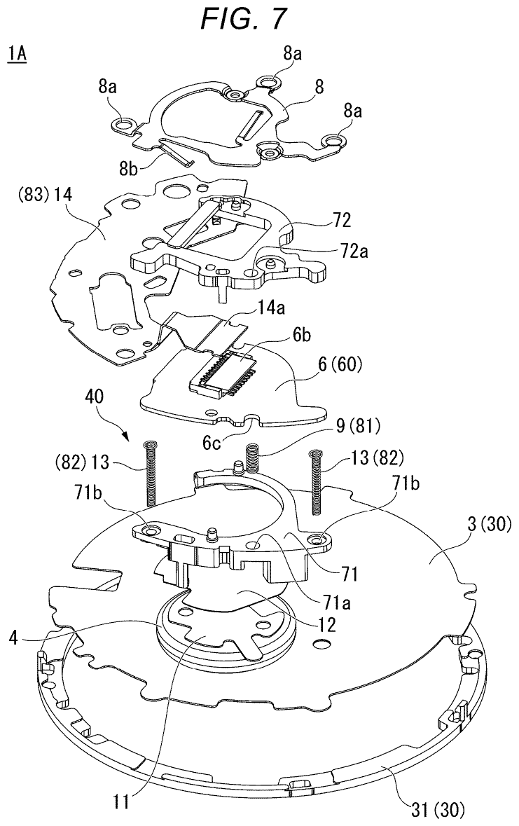

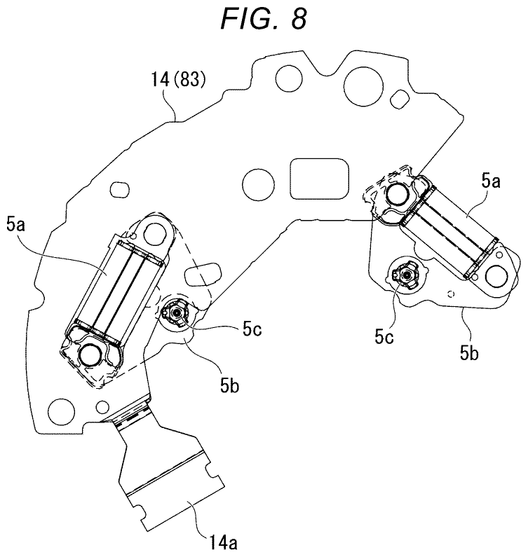

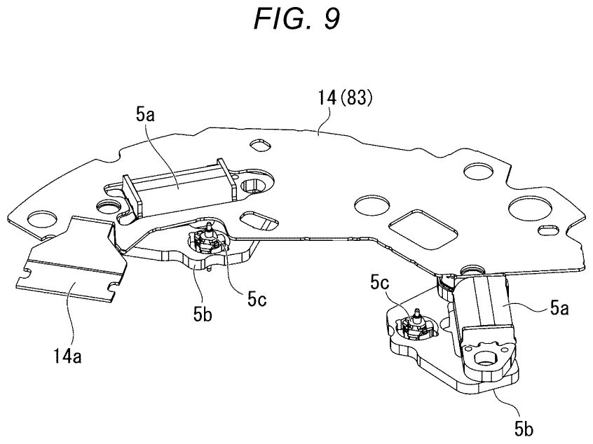

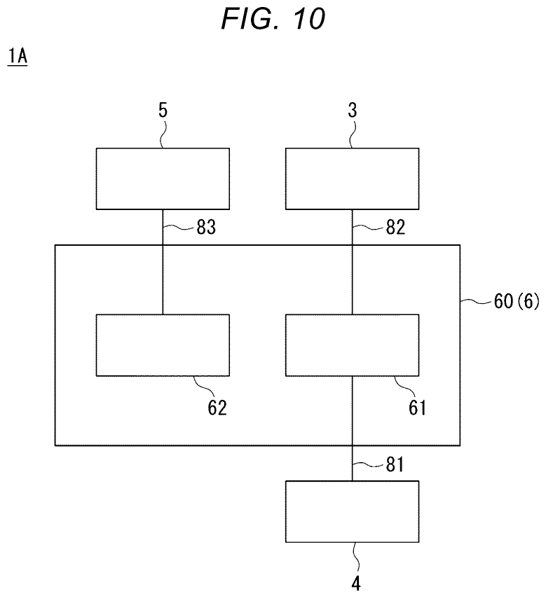

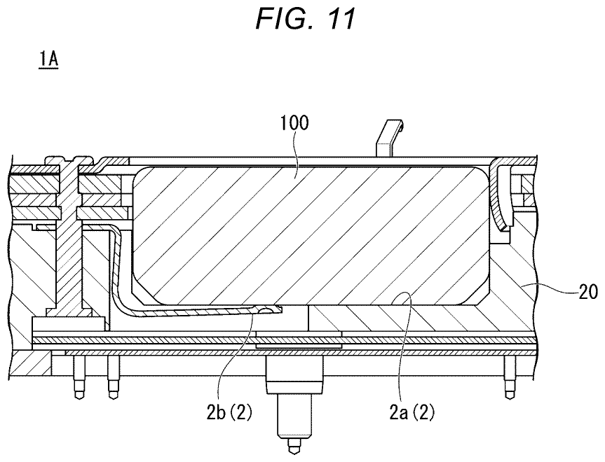

Note that FIG. 1 is a perspective view of the solar movement 1A as viewed from a case back side. FIG. 2 is a perspective view illustrating a state of the solar movement 1A with a case-back-side unit 40 removed. FIG. 3 is a cross-sectional view of the solar movement 1A. FIG. 4 is a plan view of the solar movement 1A as viewed from a dial side. FIG. 5 is an exploded perspective view of the solar movement 1A. FIG. 6 is a perspective view of a dial-side unit 30, the case-back-side unit 40, and a secondary battery 4 that form the solar movement 1A. FIG. 7 is an exploded perspective view of the dial-side unit 30, the case-back-side unit 40, and the secondary battery 4. FIG. 8 is an exploded plan view of a motor driving unit 5 and a flexible wiring board 14 that form the solar movement 1A. FIG. 9 is a perspective view of the motor driving unit 5 and the flexible wiring board 14. FIG. 10 is a block diagram of a circuit block 60 of the solar movement 1A. FIG. 11 is a cross-sectional view illustrating a state in which a primary battery 100 is disposed in a battery housing portion 2 of a movement body 20 forming the solar movement 1A.

The solar movement 1A of the present embodiment is an application of the invention to a movement of a solar electronic timepiece that can be charged by light energy such as solar light, for example, and is a movement that can be mounted on a timepiece such as a wristwatch.

Specifically, as illustrated in FIGS. 1 to 5 and 11, the solar movement 1A includes the movement body 20 including the battery housing portion 2 capable of housing the primary battery 100, the dial-side unit 30 disposed on a dial side of the movement body 20 and including at least a solar panel 3, the case-back-side unit 40 disposed on a case back side of the movement body 20 and having at least a part thereof housed in the battery housing portion 2, the secondary battery 4 housed in the battery housing portion 2, the motor driving unit 5 driven by supply of power from the secondary battery 4, and a printed wired board 6 forming the circuit block 60.

The movement body 20 is formed in a substantially circular disk shape as a whole, and has a configuration compatible with a primary battery movement. That is, the movement body 20 employs the primary battery movement driven by power supplied from the primary battery 100.

The battery housing portion 2 includes a recess 2a having a shape corresponding to the button type primary battery 100 on the case back side of the movement body 20. Inside the recess 2a, a negative electrode terminal 2b electrically connected to a negative electrode (−) side of the primary battery 100 or the secondary battery 4 is provided on a bottom surface side. The negative electrode terminal 2b is electrically connected to the circuit block 60 via the ground (not illustrated) of the movement body 20.

As illustrated in FIG. 3, the secondary battery 4 is a button-type battery having a thickness smaller than that of the primary battery 100 illustrated in FIG. 11. A negative electrode (−) side of the secondary battery 4 is electrically connected to the negative electrode terminal 2b by being housed in the recess 2a of the battery housing portion 2. On the other hand, a positive electrode (+) side of the secondary battery 4 is located lower than an opening end of the recess 2a. Accordingly, a space K for housing a part of the case-back-side unit 40 is provided above the secondary battery 4 housed in the recess 2a.

As illustrated in FIGS. 3 to 7, the dial-side unit 30 includes the solar panel 3 formed in a substantially circular disk shape corresponding to the dial side of the movement body 20, and a substantially circular ring-shaped frame body 31 fixed to the dial side of the movement body 20 while holding the periphery of the solar panel 3.

As illustrated in FIGS. 1 to 3 and FIGS. 5 to 7, the case-back-side unit 40 includes the motor driving unit 5 and the printed wired board 6 that are disposed on the case back side of the movement body 20.

As illustrated in FIGS. 8 and 9, the motor driving unit 5 includes a coil block 5a, a stator 5b, and a rotor 5c that drive a timepiece hand or the like provided in the movement body 20 by supply of power from the secondary battery 4.

The motor driving unit 5 is electrically connected to the flexible wiring board 14, and is electrically connected to the printed wired board 6 when mounted on the case-back-side unit 40. Note that, in the present embodiment, a configuration is adopted in which two motor driving units 5 each including the coil block 5a, the stator 5b, and the rotor 5c are provided, but the number of motor driving units 5 may be one, and there is no particular limitation on the number.

As illustrated in FIGS. 1, 3, and 5 to 7, the printed wired board 6 has a configuration in which a circuit chip 6a such as a CPU or an IC forming the circuit block 60 is disposed on a lower surface side and a connector 6b for external connection is disposed on an upper surface side. The printed wired board 6 has a flat plate shape corresponding to the battery housing portion 2, and is provided on the secondary battery 4 such that the circuit chip 6a is located inside the battery housing portion 2, that is, in the space K of the recess 2a.

The printed wired board 6 is attached to the case back side of the movement body 20 via a lower spacer 71 and an upper spacer 72 that are made of insulating resin. Specifically, the lower spacer 71 is disposed inside the battery housing portion 2, that is, in the space K of the recess 2a while supporting the periphery of the circuit chip 6a disposed on the lower surface side of the printed wired board 6. On the other hand, the upper spacer 72 is disposed such that the periphery of the connector 6b disposed on the upper surface side of the printed wired board 6 is sandwiched between the upper spacer 72 and the lower spacer 71.

As illustrated in FIG. 10, the circuit block 60 includes a charging circuit unit 61 that controls charging (including discharging) of the secondary battery 4 with power supplied from the solar panel 3, and a driving circuit unit 62 that controls driving of the motor driving unit 5 with power supplied from the secondary battery 4.

As illustrated in FIGS. 1, 3, 5 to 7, and 10, the solar movement 1A of the present embodiment includes a first connection unit 81 that electrically connects the secondary battery 4 and the printed wired board 6, a second connection unit 82 that electrically connects the solar panel 3 and the printed wired board 6, and a third connection unit 83 that electrically connects the motor driving unit 5 and the printed wired board 6.

The first connection unit 81 includes a pressing member 8 made of a conductive metal and provided on the printed wired board 6, and a first coil spring 9 made of a conductive metal and disposed between the secondary battery 4 and the pressing member 8.

The pressing member 8 is positioned on an upper surface side of the upper spacer 72. In the case-back-side unit 40, a plurality of (three in the embodiment) screws 10 are screwed into screw holes 20a provided on the case back side of the movement body 20 through hole portions 8a penetrating the pressing member 8, respectively. Accordingly, the lower spacer 71, the printed wired board 6, the upper spacer 72, and the pressing member 8 are integrally attached to the case back side of the movement body 20.

The pressing member 8 is provided with a positive electrode terminal 8b extending toward the printed wired board 6. When attached to the movement body 20, the pressing member 8 is electrically connected to the printed wired board 6 via the positive electrode terminal 8b.

The first coil spring 9 is disposed in a compressed state between the secondary battery 4 and the pressing member 8 through a hole portion 71a penetrating the lower spacer 71, a cutout portion 6c cutting out an end surface of the printed wired board 6, and a hole portion 72a penetrating the upper spacer 72. At this time, one end side of the first coil spring 9 is electrically connected to the positive electrode (+) side of the secondary battery 4 via a conductive plate 11 provided on the secondary battery 4. On the other hand, the other end side of the first coil spring 9 is electrically connected to the pressing member 8. An insulating plate 12 is provided on the conductive plate 11.

Accordingly, the first connection unit 81 electrically connects the secondary battery 4 and the charging circuit unit 61 of the circuit block 60 via the first coil spring 9 and the pressing member 8.

The second connection unit 82 includes at least one or more (two in the present embodiment) second coil springs 13 disposed between the solar panel 3 and the printed wired board 6. The second coil springs 13 are disposed in a compressed state between the solar panel 3 and the printed wired board 6 through a hole portion 20b penetrating the movement body 20 and a hole portion 71b penetrating the lower spacer 71, respectively. At this time, one end side of each second coil spring 13 is electrically connected to the solar panel 3. The other end side of each second coil spring 13 is electrically connected to the printed wired board 6.

Accordingly, the second connection unit 82 electrically connects the solar panel 3 and the charging circuit unit 61 of the circuit block 60 via the plurality of second coil springs 13.

As illustrated in FIGS. 1, 3, and 5 to 9, the third connection unit 83 includes the flexible wiring board 14 that electrically connects the motor driving unit 5 and the printed wired board 6. One end side of the flexible wiring board 14 is electrically connected to the coil block 5a. On the other hand, a terminal portion 14a provided on the other end side of the flexible wiring board 14 is electrically connected to the printed wired board 6 when inserted into the connector 6b.

Accordingly, the third connection unit 83 electrically connects the coil block 5a of the motor driving unit 5 and the driving circuit unit 62 of the circuit block 60 via the flexible wiring board 14.

As described above, in the present embodiment, the solar movement 1A can be easily implemented by incorporating the solar panel 3, the secondary battery 4, and the printed wired board 6 into the movement body 20 compatible with the primary battery movement described above.

According to the present embodiment, it is not necessary to separately design and manufacture the primary battery movement (movement body 20) and the solar movement 1A, and an increase in the number of components can be prevented, so that the productivity can be further improved.

Further, in the solar movement 1A of the present embodiment, by the circuit block 60 including the charging circuit unit 61 and the driving circuit unit 62 described above, the charging control of the secondary battery 4 with the power supplied from the solar panel 3 and the driving control of the motor driving unit 5 with the power supplied from the secondary battery 4 can be appropriately and efficiently performed in accordance with the solar panel 3 and the secondary battery 4. As a result, power saving of the solar movement 1A can also be achieved.

### Second Embodiment

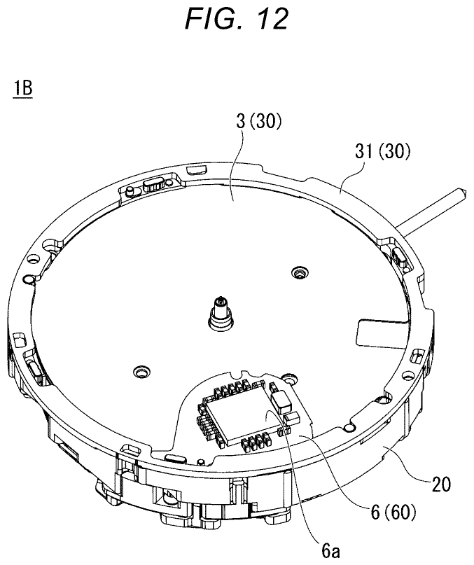

Next, for example, a solar movement 1B illustrated in FIG. 12 will be described as a second embodiment of the invention.

FIG. 12 is a perspective view of the solar movement 1B as viewed from a dial side. In the following description, portions same as those of the solar movement 1A will not be described, and the same reference numerals will be given in the drawings.

As illustrated in FIG. 12, the solar movement 1B of the present embodiment has a configuration in which the printed wired board 6 forming the circuit block 60 is provided in a region on a dial side of the movement body 20 that does not overlap the solar panel 3. Other configurations are basically the same as those of the solar movement 1A. That is, the printed wired board 6 forming the circuit block 60 can form the dial-side unit 30.

As described above, in the present embodiment, the solar movement 1B can be easily implemented by incorporating the solar panel 3, the secondary battery 4, and the printed wired board 6 into the movement body 20 compatible with the primary battery movement described above.

According to the present embodiment, it is not necessary to separately design and manufacture the primary battery movement (movement body 20) and the solar movement 1B, and an increase in the number of components can be prevented, so that the productivity can be further improved.

Further, in the solar movement 1B of the present embodiment, by the circuit block 60 including the charging circuit unit 61 and the driving circuit unit 62 described above, the charging control of the secondary battery 4 with power supplied from the solar panel 3 and the driving control of the motor driving unit 5 with the power supplied from the secondary battery 4 can be appropriately and efficiently performed in accordance with the solar panel 3 and the secondary battery 4. As a result, power saving of the solar movement 1B can also be achieved.

Note that the invention is not necessarily limited to the above-described embodiments, and various modifications can be made without departing from the spirit of the invention.

What is claimed is:

1. A solar movement comprising:
a movement body including a battery housing portion configured to house a primary battery;
a dial-side unit disposed on a dial side of the movement body and including at least a solar panel;
a case-back-side unit disposed on a case back side of the movement body and having at least a part thereof housed in the battery housing portion;
a secondary battery housed in the battery housing portion; and
a motor driving unit driven by supply of power from the secondary battery, wherein
at least one of the dial-side unit and the case-back-side unit is provided with a circuit block including
a charging circuit unit configured to control charging of the secondary battery with power supplied from the solar panel, and
a driving circuit unit configured to control driving of the motor driving unit with power supplied from the secondary battery.

2. The solar movement according to claim 1, wherein
the circuit block is provided on the secondary battery with at least a part thereof housed in the battery housing portion.

3. The solar movement according to claim 2, further comprising:
a first connection unit electrically connecting the secondary battery and the circuit block;
a second connection unit electrically connecting the solar panel and the circuit block; and
a third connection unit electrically connecting the motor driving unit and the circuit block.

4. The solar movement according to claim 3, wherein
the first connection unit includes
a pressing member provided on the circuit block and including a terminal electrically connected to the circuit block, and
a first coil spring electrically connecting the secondary battery and the pressing member.

5. The solar movement according to claim 3, wherein
the second connection unit includes a second coil spring electrically connecting the solar panel and the circuit block.

6. The solar movement according to claim 3, wherein
the third connection unit includes a flexible wiring board electrically connecting the motor driving unit and the circuit block.

7. The solar movement according to claim 1, wherein
the circuit block is provided in a region on the dial side of the movement body that does not overlap the solar panel.

8. A timepiece comprising:
the solar movement according to claim 1.
